(19) United States
(12) Patent Application Publication
(10) Pub. No.: US 2006/0066808 A1
(43) Pub. Date: Mar. 30, 2006

(54) Ophthalmic lenses incorporating a diffractive element

(76) Inventors: Ronald D. Blum, Roanoke, VA (US); William Kokonaski, Gig Harbor, WA (US); Dwight P. Duston, Laguna Niguel, CA (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/232,551

(22) Filed: Sep. 22, 2005

Related U.S. Application Data
(60) Provisional application No. 60/612,776, filed on Sep. 27, 2004.

(51) Int. Cl. G02C 7/02

(52) U.S. Cl. 351/159

(57) ABSTRACT

An ophthalmic lens is provided that comprises a correction lens having a first focal region having a first focal power and a second focal region having a second focal power different from the first focal power. The ophthalmic lens further comprises a diffractive element having a diffractive element focal power that is additive to the second focal power. In some embodiments, the second focal region is a multi-focal region that may be a progressive addition region or an electro-active region.

This application claims priority to provisional application 60/612,776 filed Oct. 27, 2004, and to U.S. patent application Ser. No. 10/627,828 filed Jul. 25, 2003, which is a continuation of U.S. patent application Ser. No. 09/602,013 filed Jun. 23, 2000, now U.S. Pat. No. 6,619,799, which claims priority to the following U.S. Provisional Patent Applications:
Ser. No. 60/142,053, titled “Electro-Active Spectacles”, filed 2 Jul. 1999;
Ser. No. 60/143,626, titled “Electro-Active Spectacles”, filed 14 Jul. 1999;
Ser. No. 60/147,813, titled “Electro-Active Refraction, Dispensing, & Eyewear”, filed 10 Aug. 1999;
Ser. No. 60/150,545, titled “Advanced Electro-Active Spectacles”, filed 25 Aug. 1999;
Ser. No. 60/150,564, titled “Electro-Active Refraction, Dispensing, & Eyewear”, filed 25 Aug. 1999; and
Ser. No. 60/161,363, titled “Comprehensive Electro-Active Refraction, Dispensing, & Eyewear” filed 26 Oct. 1999;
   all of which are incorporated herein by reference in their entirety.

The subject matter of the invention relates to the following, which are incorporated herein by reference in their entirety:
“System, Apparatus and Method for Correcting Vision Using an Electro-Active Lens”, U.S. application Ser. No. 10/626,973 filed Jul. 25, 2003, now U.S. Pat. No. 6,918,670.
“System, Apparatus, and Method for Correcting Vision Using Electro-Active Spectacles”, U.S. application Ser. No. 09/602,012, filed Jun. 23, 2000, now U.S. Pat. No. 6,517,203;
“Method for Refracting and Dispensing Electro-Active Spectacles”, U.S. application Ser. No. 09/602,014, filed Jun. 23, 2000, now U.S. Pat. No. 6,491,394; and
“System, Apparatus, and Method for Reducing Birefringence”, U.S. application Ser. No. 09/603,736, filed Jun. 23, 2000, now U.S. Pat. No. 6,491,391.

### BACKGROUND OF THE INVENTION

The present invention relates generally to the field of ophthalmic lenses and, in particular, ophthalmic lenses that incorporate diffractive lenses in a unique manner.

Presbyopia affects nearly 93% of the population in their mid forties and older. Conventional ophthalmic lenses do not adequately address the problems associated with presbyopia. A particular aspect that is not addressed by conventional lenses is the need for a larger depth of focus. Recent advancements in mathematical modeling have resulted in diffractive elements capable of producing a range of depth of focus. Depending on the diameter of the diffractive element the range of depth of focus can be quite large. It is well known in the art that a smaller diameter will yield a larger depth of focus. The invention contained here in provides an approach to maximizing the depth of focus of ophthalmic lenses while taking into account the need for a larger diameter for correction. Through unique combinations of novel lens elements, the present invention balances the need for a larger diameter while satisfying the visual need of a broad range of depth of focus.

### SUMMARY OF THE INVENTION

An illustrative embodiment of the invention provides an ophthalmic lens comprising a correction lens having a first focal region having a first focal power and a second focal region having a second focal power different from the first focal power. The ophthalmic lens further comprises a diffractive element having a diffractive element focal power that is additive to the second focal power. In some embodiments, the second focal region is a multi-focal region that may be a progressive addition region or an electro-active region.

### BRIEF DESCRIPTION OF THE DRAWINGS

The invention will be more readily understood through the following detailed description, with reference to the accompanying drawings, in which:

FIG. 1 is a front view of an embodiment of an ophthalmic lens comprising a normal distance prescription lens and a de-centered diffractive element.

FIG. 2 is a front view of an embodiment of an ophthalmic lens comprising a progressive addition region and a diffractive element.

FIG. 3 is a front view of an embodiment of an ophthalmic lens comprising an electro-active region and a diffractive element.

### DETAILED DESCRIPTION

The present invention provides ophthalmic lenses that make use of diffractive elements to provide a broader range of depth of focus than would be provided by conventional lenses. As used herein, the term “ophthalmic lens” is intended to encompass any lens used for vision enhancement or correction including lenses having one or more optical elements or regions including refractive, diffractive, progressive addition, multi-focal, and electro-active elements or regions.

The diffractive elements used in the lenses of the invention may be combined in various embodiments to provide a variety of advantageous characteristics. In some embodiments, diffractive elements are placed on an ophthalmic lens in such a way that the wearer can selectively increase his depth of focus by directing his gaze through the region of the lens where the diffractive element is located. In some of these embodiments, the diffractive element may be co-located with other lens features such as a progressive addition region or other multi-focal region (such as traditional bifocal lenses). In some embodiments, diffractive elements may be used in combination with electro-active regions included in the ophthalmic lens. In some embodiments, diffractive elements may be used in combination with electro-active regions and progressive addition regions or other multi-focal regions.

Diffractive elements may be formed through modification of a portion of an existing lens or lens blank, such as by etching, machining, or diamond turning. Alternately, diffractive elements may be integrally formed on a lens surface through the use of a molding process that leaves a diffractive pattern on the lens surface. A diffractive element may also be a separate physical element that is attached to or embedded inside of the ophthalmic lens.

To assist with understanding certain embodiments of the invention, explanations of various terms are now provided. In some situations, these explanations are not necessarily intended to be limiting, but, should be read in light of the examples, descriptions, and claims provided herein.

An “electro-active zone” can include or be included in an electro-active structure, layer, and/or region. An “electro-active region” can be a portion and/or the entirety of an electro-active layer. An electro-active region can be adjacent to another electro-active region. An electro-active region can be attached to another electro-active region, either directly, or indirectly with, for example, an insulator between each electro-active region. An electro-active layer can be attached to another electro-active layer, either directly, or indirectly with, for example, an insulator between each electro-active layer. “Attaching” can include bonding, depositing, adhering, and other well-known attachment methods. A “controller” can include or be included in a processor, a microprocessor, an integrated circuit, an IC, a computer chip, and/or a chip. A “refractor” can include a controller. An “auto-refractor” can include a wave front analyzer. “Near distance refractive error” can include presbyopia and any other refractive error needed to be corrected for one to see clearly at near distance. “Intermediate distance refractive error” can include the degree of presbyopia needed to be corrected an intermediate distance and any other refractive error needed to be corrected for one to see clearly at intermediate distance. “Far distance refractive error” can include any refractive error needed to be corrected for one to see clearly at far distance. “Near distance” can be from about 6 inches to about 24 inches, and more preferably from about 14 inches to about 18 inches. “Intermediate distance” can be from about 24 inches to about 5 feet. “Far distance” can be any distance between about 5 feet and infinity, and more preferably, infinity. “Conventional refractive error” can include myopia, hyperopia, astigmatism, and/or presbyopia. “Non-conventional refractive error” can include irregular astigmatism, aberrations of the ocular system, and any other refractive error not included in conventional refractive error. “Optical refractive error” can include any aberrations associated with a lens optic.

In certain embodiments, a “spectacle” can include one lens. In other embodiments, a “spectacle” can include more than one lens. A “multi-focal” lens can include bifocal, trifocal, quadrafocal, and/or progressive addition lens. A “finished” lens blank can include a lens blank that has finished optical surface on both sides. A “semi-finished” lens blank can include a lens blank that has, on one side only, a finished optical surface, and on the other side, a non-optically finished surface, the lens needing further modifications, such as, for example, grinding and/or polishing, to make it into a useable lens. “Surfacing” can include grinding and/or polishing off excess material to finish a non-finished surface of a semi-finished lens blank.

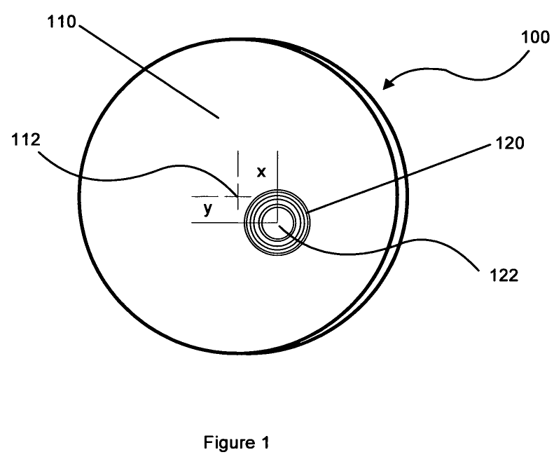

FIG. 1 is a front view of an ophthalmic lens 100 according to an embodiment of the invention. The ophthalmic lens 100 may be a spectacle lens, or may be an intraocular lens. The lens 100 comprises a conventional distance prescription lens 110 (for example, a single focus lens to correct far distance refractive error) and a diffractive element 120. The diffractive element 120 is positioned so that it is “de-centered” relative to the optical center 112 of the conventional lens 110. Specifically, the diffractive element 120 has an element optical center 122 that is positioned with an offset x in the horizontal direction and an offset y in the vertical direction relative to the optical center 112 of the conventional lens 110. In particular embodiments, either or both of the offsets x and y may be in a range from 0 to about 10. This allows the wearer of such a lens to see through his normal distance prescription without any ill effects of distortions potentially associated with the introduction of the diffractive element.

An optical center is defined as the point where an optical axis of a lens intersects an orthogonal cross section of the lens. Generally, but not always, the optical axis of a lens is aligned with the pupil of the eye. Generally, but not always, the optical axis of a lens is also the geometric center of the lens.

The diffractive element 120 may be sized and configured to provide a desired depth of focus. Typically, the conventional distance prescription lens 110 (including plano) may provide for distances from 4 feet to infinity. The de-centered diffractive element 120 could thus be configured to allow for distances from 4 feet to 18 inches or closer.

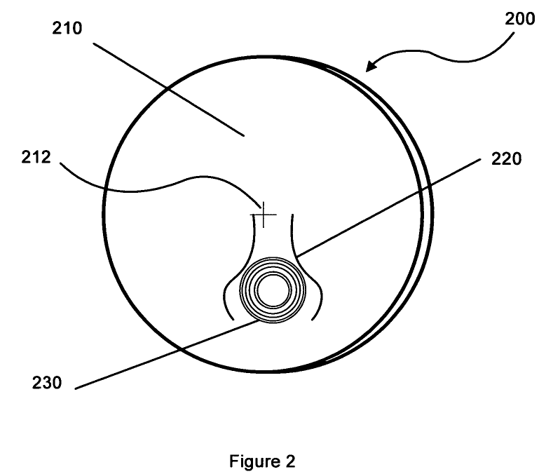

FIG. 2 is a front view of an ophthalmic lens 200 according to an embodiment of the invention. The ophthalmic lens 200 may be a spectacle lens, or may be an intraocular lens. The ophthalmic lens 200 comprises a conventional distance correction lens 210 having a progressive addition region 220 and a diffractive element 230. This provides a diffractive lens with a defined depth of focus in combination with a progressive addition lens. The progressive addition region 220 of the lens 210 may be configured to provide a relatively weak progressive addition with little distortion. By way of example only, the progressive addition region may have an addition power ranging from between +0.5 and +1.0 diopters. The diffractive element may be configured with a depth of field of between 2.0 and 2.5 diopters. This corresponds to a distance measure of 0.4 to 0.5 meters.

The ophthalmic lens 200 may be configured to provide a full range of addition powers for presbyopic patients using the same lens design. Particularly satisfactory results may be achieved using a combination of progressive power and depth of focus results in a lens that provides for accommodative correction of between 1 and 3 diopters, with no more than 1 diopter of fixed optical addition. This further allows for the possibility of increasing the progressive power of the progressive addition region 220 and allowing for a reduction in the depth of field of the diffractive element 230 while increasing the diameter of the diffractive element 230. It will be understood by those of ordinary skill in the art that the reverse is also the case. It is possible to further reduce the power of the progressive addition region 220 while reducing the size of the diffractive element 230 to increase the depth of field. Thus, the ophthalmic lens 200 can be configured so as to optimize the combination of power of the progressive addition region 220, the diameter of the diffractive element 230 and the configuration of the diffractive element 230 to produce a desired depth of field.

As is shown in FIG. 2, the progressive addition region 220 and the diffractive element 230 may be positioned away from the optical center 212 of the conventional lens 210. This allows the wearer to selectively view through the progressive addition region 220 and/or the diffractive element 230.

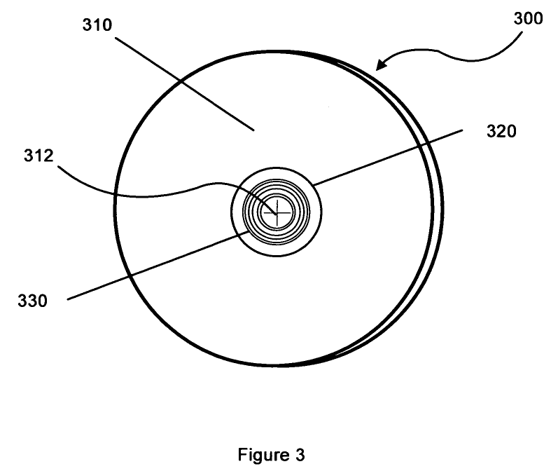

FIG. 3 is a front view of an ophthalmic lens 300 according to an embodiment of the invention. The ophthalmic lens 300 may be a spectacle lens, or may be an intraocular lens. The ophthalmic lens 300 comprises a conventional distance correction region 310, an electro-active lens region 320 and a diffractive element 330. The electro-active region 320 may be configured according to any of the embodiments described in co-pending U.S. application Ser. No. 10/627,828, which has been incorporated herein by reference.

In this embodiment, the diffractive element 330 is configured with a predetermined depth of field for use in combination with the electro-active region 320 to produce an effect similar to that described above for the ophthalmic lens 200 of FIG. 2. In the ophthalmic lens 300, however, the effect of the electro-active region 320 may be selectively turned on and off. As a result, the combined electro-active lens region and the diffractive element may be placed at or near the optical center 312 of the conventional lens region 310. The resulting ophthalmic lens 300 has minimal unwanted distortion because the electro-active region 320 produces no distortion in the off state. Further, the diffractive element 330 can be configured to have a relatively small depth of focus, since it is being used in conjunction with an electro-active lens.

The electro-active region 320 may be configured to have a fixed focus (i.e., a single optical power in the on-state) or may be continuously variable form zero to some maximum optical power. The lens 300 allows for the possibility of increasing the power of the electro-active element 330 and allowing for a reduction in the depth of field of the diffractive element 330 while increasing the diameter of the diffractive element 330. However, it also allows for the reduction of the optical power demands of the electro-active region 320 and for the option of increasing its diameter when adding a diffractive element 330 that contributes depth of field.

It will thus be understood by those of ordinary skill in the art that the ophthalmic lens 300 can be configured so as to optimize the combination of power of the electro-active lens region 320, the diameter of the diffractive element 330 and the configuration of the diffractive element 330 to produce a desired depth of field.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from the spirit or essential attributes.

What is claimed is:

1. An ophthalmic lens comprising:
a correction lens having a first focal region having a first focal power and a second focal region having a second focal power different from the first focal power; and
a diffractive element having a diffractive element focal power that is additive to the second focal power.

2. The ophthalmic lens of claim 1, wherein the second focal region is a multi-focal region.

3. The ophthalmic lens of claim 2 wherein the second focal region is a progressive addition region that provides an addition power.

4. The ophthalmic lens of claim 3, wherein the addition power is in a range of about +0.5 diopters to about +1.0 diopters.

5. The ophthalmic lens of claim 3, wherein the addition power and the diffractive element focal power are adapted to provide a combined depth of field in a predetermined range.

6. The ophthalmic lens of claim 2, wherein the second focal region is an electro-active region adapted for selectively varying the second focal power.

7. The ophthalmic lens of claim 6, wherein the second focal power and the diffractive element focal power are adapted to provide a combined depth of field in a predetermined range.

8. The ophthalmic lens of claim 1, wherein the first focal region has a fixed focus.

9. The ophthalmic lens of claim 1, wherein the second focal region is an electro-active region adapted for selectively increasing the optical power of at least a portion of the ophthalmic lens by a fixed amount.

10. The ophthalmic lens system of claim 1, wherein the diffractive element is formed on a rear surface of the correction lens in the second focal region.

11. The ophthalmic lens of claim 1 wherein the diffractive element is formed by removing material from the rear surface of the correction lens.

12. The ophthalmic lens of claim 1 wherein the diffractive element is integrally formed with the correction lens.

13. The ophthalmic lens of claim 1 wherein the diffractive element is a distinct lens element attached to the correction lens.

14. The ophthalmic lens of claim 1, wherein the ophthalmic lens is a spectacle lens.

15. The ophthalmic lens of claim 1, wherein the ophthalmic lens is an intraocular lens.

16. The ophthalmic lens of claim 1, wherein the first focal region has a first optical center and the diffractive element has a diffractive element optical center spaced apart from the first optical center by an offset including at least one of a horizontal offset in a horizontal direction and a vertical offset in a vertical direction.

17. The ophthalmic lens of claim 16, wherein the horizontal and vertical offsets are each in a range of about 0 mm to about 10 mm.

18. The ophthalmic lens of claim 1, wherein the diffractive element has a depth of focus in a range of about 0 to about 4 feet.

19. The ophthalmic lens of claim 1, wherein the diffractive element has a depth of focus corresponding to a range of about 1 diopter to about 3 diopters.

20. The ophthalmic lens of claim 1 wherein said diffractive element is adapted to provide a depth of focus for enhancing vision.
